(19) United States
(12) Patent Application Publication
(10) Pub. No.: US 2005/0014493 A1
(43) Pub. Date: Jan. 20, 2005

(54) Apparatus and method of wireless data exchange with automatic delivery confirmation

(76) Inventor: Gordon Ford, Round Rock, TX (US)

Correspondence Address: ANTHONY EDW. J CAMPBELL, PO BOX 160370, AUSTIN, TX, 78716, US

(21) Appl. No.: 10/891,250

(22) Filed: Jul. 14, 2004

Related U.S. Application Data
(60) Provisional application No. 60/487,133, filed on Jul. 15, 2003.

(51) Int. Cl. H04M 3/00

(52) U.S. Cl. 455/418; 455/466

(57) ABSTRACT

A method of wireless data exchange with automatic delivery confirmation including a managing step for managing the wireless data message, a transmitting step to transmit the wireless data message via a wireless network to the server memory, a storing step for storing the wireless data message in the server memory, a confirming step for confirming storage of the wireless data message utilizing server software, a sending step for sending a confirmation to the wireless telephone upon confirming storage of the wireless data message in the server memory and a deleting step for deleting the wireless data message in the wireless telephone memory.

### RELATED APPLICATION

This application is based on Provisional Application 60/487,133 filed Jul. 15, 2003.

### BACKGROUND OF THE INVENTION

1. Field of the Invention

The present embodiment of the invention relates to an apparatus and method of wireless data exchange with automatic delivery confirmation for use in connection with wireless communication devices. The apparatus and method of wireless data exchange with automatic delivery confirmation has particular utility in connection with wireless communication device having automatic confirmation of wireless message content delivery.

2. Description of the Prior Art

Wireless communications devices are widely used to store messages but have limited storage space, so that eventually their data files must be deleted so that new messages can be created. For example, a wireless phone with a camera can store a limited number of digital pictures in its own memory. Once that limit is reached, the phone's user must delete some of the stored pictures before taking new ones.

The user of a wireless device generally does not want to delete stored data files until they are stored at another location. In one current technique, the user of a wireless device can manually transmit messages (data files) stored on the device to a remote storage location such as a PC or an Internet site, and then manually delete the files from the wireless device. For example, a user of a wireless phone with a camera can employ the interface on the phone to transmit his stored pictures as messages via wireless communications to a PC or an Internet site. After transmitting the pictures, the user can employ the phone's interface to delete them from the phone.

The user usually prefers to confirm the safe receipt of transmitted data at a storage location before deleting files from his device. Accordingly, in a second, related technique the user of the wireless device can take the extra step of visually examining the data files he has stored at the remote location. To do this he can manually transmit messages containing the data files stored on the device to a remote storage location. Subsequently he can access that location to verify that the files have been safely received and stored there, and then manually delete the files from the wireless device. For example, the user of a wireless camera phone can transmit pictures as messages to a PC or an Internet site, access the remote location, look at the pictures stored there, and only then delete the pictures stored on the camera phone.

One limitation of the first technique is that it must be done manually, which is slow and requires the user's attention and skill. Furthermore, it is uncertain, since the user cannot be sure that the messages sent to a remote location were received successfully.

The second technique, which is also manual, is slow and requires the user's attention and skill, and has the additional complication of requiring the user to access a remote storage device to verify the successful reception there of transmitted messages. The delay for verification can cause a user to be unable to store new files on a wireless device that has reached its storage limit. Furthermore, the user must visually examine for accuracy the data received and stored on the remote site, which, because of the limitations of human sight, is an inexact method of validating successful reception.

The use of wireless communication devices is known in the prior art. For example, U.S. Pat. No. 5,999,525 to Krishnaswamy et al. discloses a method for video telephony over a hybrid network where video, audio and data is routed through a switched network which includes transfer of information across the internet. Users can transmit video, audio and data communications of designated quality over the internet to other registered video telephony users. However, the Krishnaswamy et al. '525 patent does not automatically confirm storage of the data and does not automatically delete the data upon receipt of the confirmation.

Similarly, U.S. Pat. No. 6,538,623 to Parnian et al. discloses a wearable and mobile multi-media data collection tool kit for creating an electronic investigation record. The wearable and mobile multi-media data collection tool kit includes an electronic multi-media “Case” file for processing a plurality of multi-media data collection input streams of multi-media investigation information into an electronic case file record, a man-to-machine visual interface or display integrated with the electronic multi-media case file for visually conveying the contents of the input streams of the multi-media investigation information. The tool kit further includes a plurality of multi-media data collection tools for inputting the plurality of multi-media data collection input streams of the multi-media investigation information. However, the Parnian et al. '623 patent does not automatically confirm storage of the data and does not automatically delete the data upon receipt of the confirmation.

Likewise, U.S. Pat. No. 6,731,625 to Eastep et al. discloses a system, method and article of manufacture for a call back architecture in a hybrid network with support for internet telephony utilizing a hybrid telecommunication system including a switched communication network and a packet transmission network. A call parameter database is stored in a memory. A call is received on the system. The call parameter database is accessed to determine at least one call parameter. The call is routed over the switched communication network and the packet transmission network based on the at least one call parameter. However, the Eastep et al. '625 patent does not automatically confirm storage of the data and does not automatically delete the data upon receipt of the confirmation.

Further, U.S. Pat. No. 6,715,003 to Safai discloses a digital camera and method for communicating digital image and at least one address image stored in the camera to a remotely located service provider having a handheld digital camera that can send to the photo service provider one or more digital images with address information (e.g., one or more address image created in the camera) indicating destinations for the digital images or photographic prints. One or more additional images or instructions associated with the delivery addresses can indicate the size or quantity of the prints to be delivered. The camera can be coupled to a data communication network through which the camera directly sends the selected images to the photo service provider. At a server of the service provider, one or more photographic prints of the selected images are automatically printed, packaged, and sent to the delivery addresses. However, the Safai '003 patent does not automatically confirm storage of the data and does not automatically delete the data upon receipt of the confirmation.

Lastly, U.S. Pat. No. 5,694,334 to Donahue et al. discloses a method and apparatus for electronic distribution of digital multi-media information for automatically organizing, managing, and distributing digital multi-media information without the negative artifacts which are normally introduced when electronically distributing digitally compressed data and information which contains still images, moving images and sound. The invented system packages and assists in production and electronic distribution of pre-produced multi-media information into digital packets or segments of varying file lengths with defined start and end points. Each segment of multi-media information is identified with separate alpha-numeric and binary coded data fields which are organized into multimedia “object descriptors” and multi-media “segment descriptors”. Object descriptor fields define the actual multi-media object and its relative mixture of digitized audio, video, text, and picture content its life span for use, date and time release information for use, kill-date, and file sizes. The “segment descriptor” information packet identifies the starting point of the segment, the ending point of the segment, the segment title and related information namely, the type and configuration of each multi-media information segment. However, the Donahue et al. “334 patent does not automatically confirm storage of the data and does not automatically delete the data upon receipt of the confirmation.

While the above-described devices fulfill their respective, particular objectives and requirements, the aforementioned patents do not describe an apparatus and method of wireless data exchange with automatic delivery confirmation that allows wireless communication device having automatic confirmation of wireless message content delivery. The Krishnaswamy et al. '525, Parnian et al. '623, Eastep et al. '625, Safai '003 and Donahue et al. '334 patents make no provision for automatically confirming storage of the data and do not automatically delete the data upon receipt of the confirmation.

Therefore, a need exists for a new and improved apparatus and method of wireless data exchange with automatic delivery confirmation which can be used for wireless communication device having automatic confirmation of wireless message content delivery. In this regard, the present embodiment of the invention substantially fulfills this need. In this respect, the apparatus and method of wireless data exchange with automatic delivery confirmation according to the present embodiment of the invention substantially departs from the conventional concepts and designs of the prior art, and in doing so provides an apparatus primarily developed for the purpose of wireless communication device having automatic confirmation of wireless message content delivery.

### SUMMARY OF THE INVENTION

In view of the foregoing disadvantages inherent in the known types of wireless communication devices now present in the prior art, the present embodiment of the invention provides an improved apparatus and method of wireless data exchange with automatic delivery confirmation, and overcomes the above-mentioned disadvantages and drawbacks of the prior art. As such, the general purpose of the present embodiment of the invention, which will be described subsequently in greater detail, is to provide a new and improved apparatus and method of wireless data exchange with automatic delivery confirmation and method which has all the advantages of the prior art mentioned heretofore and many novel features that result in a apparatus and method of wireless data exchange with automatic delivery confirmation which is not anticipated, rendered obvious, suggested, or even implied by the prior art, either alone or in any combination thereof.

To attain this, the present embodiment of the invention essentially includes a managing step for managing the wireless data message. A transmitting step to transmit the wireless data message via a wireless network to the server memory. A storing step for storing the wireless data message in the server memory. A confirming step for confirming storage of the wireless data message utilizing server software. A sending step for sending a confirmation to the wireless telephone upon confirming storage of the wireless data message in the server memory and a deleting step for deleting the wireless data message in the wireless telephone memory.

There has thus been outlined, rather broadly, the more important features of the embodiment of the invention in order that the detailed description thereof that follows may be better understood and in order that the present contribution to the art may be better appreciated. The present embodiment of the invention may also include a validating step to validate the transmission of the wireless data message to the server memory. There are, of course, additional features of the present embodiment of the invention that will be described hereinafter and which will form the subject matter of the claims attached.

Numerous objects, features and advantages of the present embodiment of the invention will be readily apparent to those of ordinary skill in the art upon a reading of the following detailed description of presently preferred, but nonetheless illustrative, embodiments of the present embodiment of the invention when taken in conjunction with the accompanying drawings. In this respect, before explaining the current embodiment of the embodiment of the invention in detail, it is to be understood that the embodiment of the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present embodiment of the invention.

It is therefore an object of the present embodiment of the invention to provide a new and improved apparatus and method of wireless data exchange with automatic delivery confirmation that has all of the advantages of the prior art wireless communication devices and none of the disadvantages.

It is another object of the present embodiment of the invention to provide a new and improved apparatus and method of wireless data exchange with automatic delivery confirmation that may be easily and efficiently manufactured and marketed.

An even further object of the present embodiment of the invention is to provide a new and improved apparatus and method of wireless data exchange with automatic delivery confirmation that has a low cost of manufacture with regard to both materials and labor, and which accordingly is then susceptible of low prices of sale to the consuming public, thereby making such apparatus and method of wireless data exchange with automatic delivery confirmation economically available to the buying public.

Still another object of the present embodiment of the invention is to provide a new apparatus and method of wireless data exchange with automatic delivery confirmation that provides in the apparatuses and methods of the prior art some of the advantages thereof, while simultaneously overcoming some of the disadvantages normally associated therewith.

Even still another object of the present invention is therefore to provide a method and apparatus for a more automatic transmission of wireless data message stored on a wireless device for storage at a remote server.

Still yet another object of the present invention is to provide for the accurate and automatic confirmation of the safe storage of the content of messages transmitted from a wireless device to a remote server.

Lastly, it is an object of the present embodiment of the invention to provide for the automatic deletion of wireless data message stored on a wireless device after confirmation of the successful storage of that data on a remote server.

Server software for this invention operates on a remote storage location such as the server for an Internet site. Corresponding telephone software for this invention operates on a wireless device, such as a cell telephone with a camera. The user of the device can employ the telephone software and the interface on his device to specify to the storage location any of a wide range of possible techniques for how his device will manage, transmit, and delete data stored there. He can also use his device's interface to access the server memory location and specify how his messages are to be managed there. Afterwards the user can transmit wireless data messages to the server memory location. These messages, which include embedded data, such as a header, identifying their content, travel via a wireless network and then over the Internet to the remote server, where they are automatically managed according to the user's previous specifications. The server for the site uses the server software to read the messages' embedded data to validate the successful storage of the content of the wireless data messages. After validating the messages, the server transmits a wireless confirmation message to the wireless device, which automatically uses the telephone software to delete the corresponding wireless data message files stored on it, freeing up telephone memory space.

These together with other objects of the embodiment of the invention, along with the various features of novelty that characterize the embodiment of the invention, are pointed out with particularity in the claims annexed to and forming a part of this disclosure. For a better understanding of the embodiment of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The embodiment of the invention will be better understood and objects other than those set forth above will become apparent when consideration is given to the following detailed description thereof Such description makes reference to the annexed drawings wherein:

FIG. 1 is a block diagram view of the preferred embodiment of the apparatus and method of wireless data exchange with automatic delivery confirmation constructed in accordance with the principles of the present invention.

FIG. 2 is a block diagram view of the apparatus and method of wireless data exchange with automatic delivery confirmation of the present embodiment of the invention.

FIG. 3 is a block diagram view of the apparatus and method of wireless data exchange with automatic delivery confirmation of the present embodiment of the invention.

The same reference numerals refer to the same parts throughout the various figures.

### DESCRIPTION OF THE PREFERRED EMBODIMENT

The method of the present invention involves loading software on the wireless device to provide embedded data, such as the header, identifying the content of transmitted messages. Corresponding software on the remote storage device that can receive wireless messages enables it to read this embedded information and determine whether the message it has received and stored contains the proper content. After validating the messages, the server transmits the wireless confirmation message to the wireless device, which automatically employs its software to delete the corresponding data files stored on it, freeing up memory space.

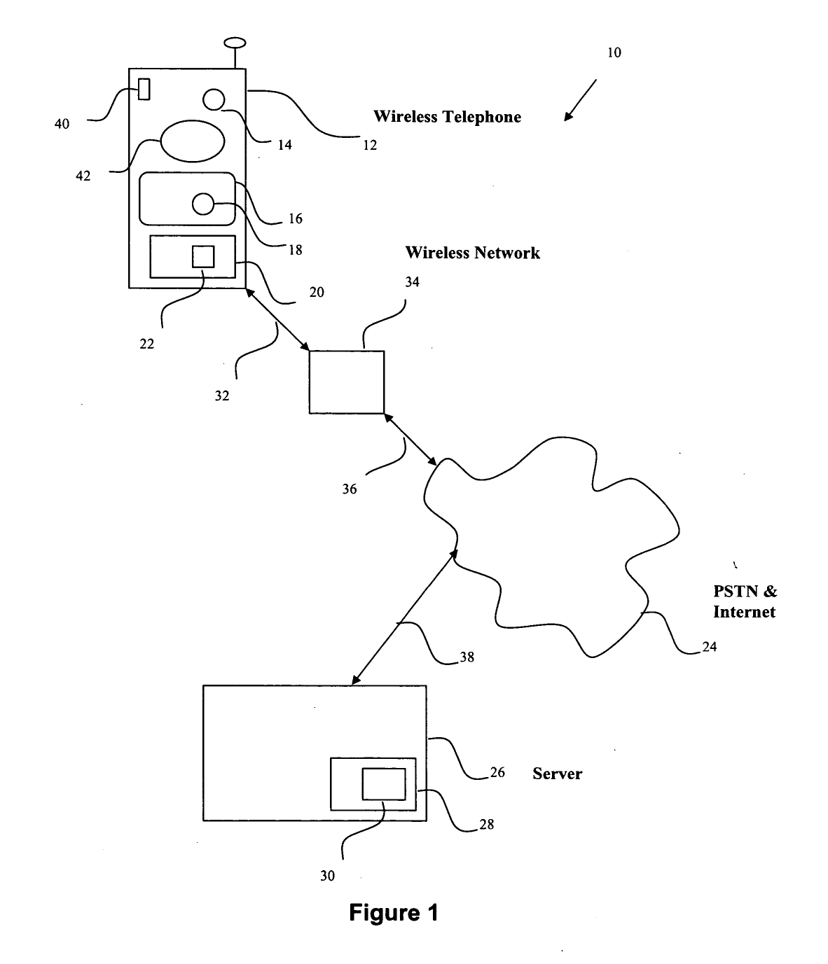

One embodiment of the present invention is shown in FIG. 1, where a wireless telephone 12 is able to communicate, via a wireless network 34 and then over the PSTN (Public Switched Telephone Network) and an Internet 24, with a server 26 of the Internet site.

The wireless telephone 12 is equipped with date and time stamp features, a digital camera 14 for still photos and video, a microphone 40, a telephone display 42, a keyboard interface 16 with a send button 18, and a telephone memory 20. A telephone software 22 for the present embodiment of the invention is stored in telephone memory 20, where it operates in association with other phone-resident software. The wireless telephone 12 may optionally be equipped with global positioning system (GPS) technology.

The user of the wireless telephone 12 accesses the server 26 either from his wireless telephone 12 or from another communications device and specifies to the server 26 how it will manage, transmit, and delete data stored on his wireless telephone 12. In the current embodiment of this invention, he has the option of having wireless data messages automatically deleted from his wireless telephone 12 or not.

A server software 30 for the present invention in a server memory 28 on the server 26 operates in association with other server-resident software. The user of the wireless telephone 12 can also accesses the server 26 either from his wireless telephone 12 or from another communications device and specify to the server 26 how he wants it to manage the wireless data messages he will send there for storage. For example, he can set up distribution lists to which he wants his wireless data messages forwarded from the server 26.

When the user of the wireless telephone 12 employs the keyboard interface 16 and the digital camera 14 to take the digital picture, that picture is stored as the data file in the telephone memory 20. In addition, the user can employ the keyboard interface 16 to record the sound message about the picture, through the microphone 40, to type in the caption and the longer text message to accompany the picture, and to select the distribution list or lists to which he wants the picture and its accompanying information to be transmitted from the server 26. All this message content data is stored in telephone memory 20.

After taking the picture and entering any additional information about it, the user presses the send button 18, which causes the phone to employ the present invention's telephone software 22 to prepare the message.

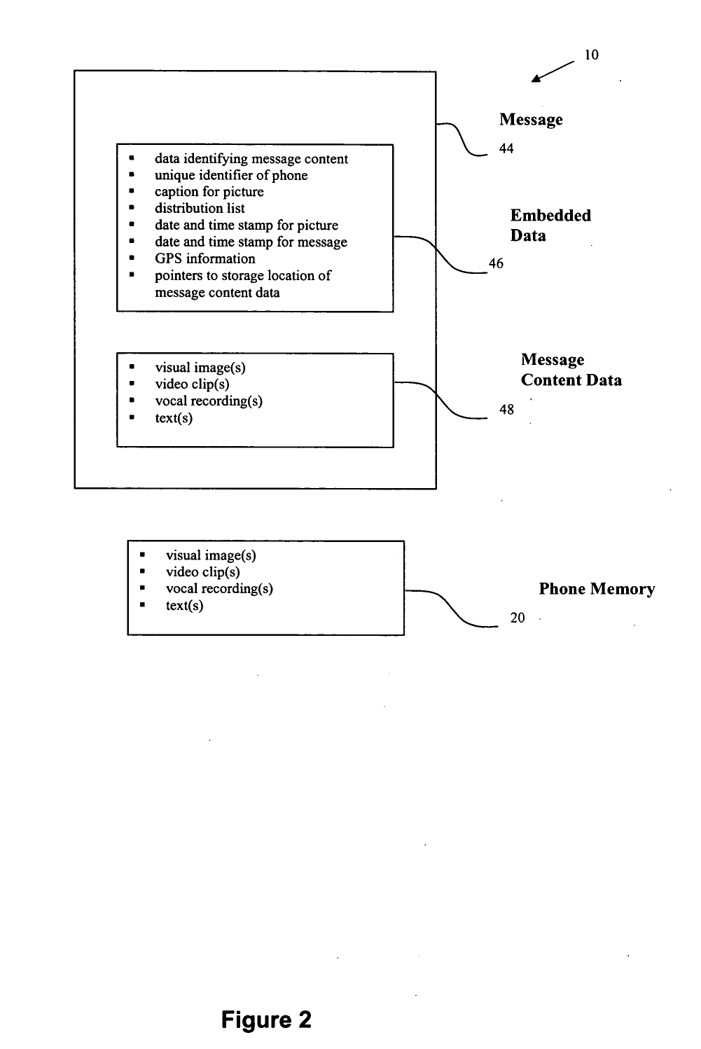

As illustrated in FIG. 2, a message 44 contains a set of embedded data 46 and a set of message content data 48. The embedded data 46 contains data identifying the content of the message, the unique identifier for the phone (the phone number and International Mobile Equipment Identification (IMEI) data about the phone's hardware), the caption for the picture, the distribution list or lists to which the user wants to transmit the picture, the date and time stamp for when the picture was taken, the date and time stamp for when the message itself is submitted for transmission, and GPS information about where the picture was taken, if available. It also contains pointers that show the location of picture data in the telephone memory 20.

The message content data 48 contains data for the visual image or video clip, and any sound recording, and text, such as, for example, JPG, MPG, WAV, and TXT files. Although the use of picture data is discussed throughout this invention, using the method of this invention solely for voice content or text messaging does not deviate from the spirit and scope of the present invention, as those skilled in the art will readily appreciate that the methods disclosed can be used for a wide range of data.

To return to the process illustrated in FIG. 1, after preparing the message, the telephone software 22 causes the wireless telephone 12 to automatically transmit the message via a wireless link 32 to the wireless network 34, then over a first wired link 36 to the Internet 24, and then over a second wired link 38 to the server 26 of the Internet storage site. After receiving the message, the server 26 uses the present invention's server software 30 stored in its server memory 28 to read the information in the message's embedded data about the content of the message. If the content of the received message matches the content specified in the embedded data, the server software 30 causes the server 26 to automatically transmit the message content data to the distribution list or lists the user of the wireless telephone 12 has selected and to store it in its server memory 28. A match can be verified using any number of techniques known in the art, such as checksum or CRC error detection. It also transmits to the wireless telephone 12 the confirmation message containing data that uses the pointers in the embedded data of the message to identify the message content data stored in the telephone memory 20 for the specific picture, displays the indication on the telephone display 42 confirming successful receipt of the content of the message for that picture and instructs the telephone software 22 on the wireless telephone 12 to automatically delete the message content data files for that picture, if the user of the wireless telephone 12 has specified for deletion to be enabled.

If the content of the received message does not match the content specified in the embedded data, the server software 30 causes the server 26 to automatically transmit to the wireless telephone 12 the request for retransmission of the message. Or, according to parameters the user of the wireless telephone 12 sets up on the server 26, the server software 30 causes the server 26 to automatically transmit to the telephone display 42 the indication that the message cannot be received successfully, in which case the message is not automatically deleted.

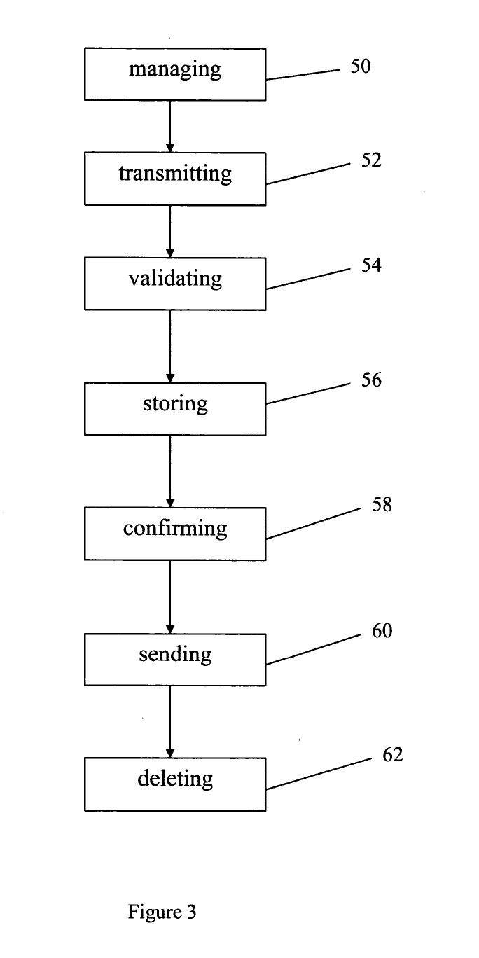

In FIG. 3, an apparatus and method of wireless data exchange with automatic delivery confirmation 10 of the present invention for wireless communication device having automatic confirmation of wireless message content delivery is illustrated and will be described. More particularly, the method of wireless data exchange with automatic delivery confirmation comprises the following steps. A managing step 50 manages the wireless data message in the telephone memory of the wireless telephone utilizing telephone software to determine the server memory for remote storage of the wireless data message. A transmitting step 52 transmits the wireless data message via the wireless network to the server memory. A validating step 54 validates the transmission of the wireless data message to the server memory. The validation is performed utilizing cyclic redundancy code, or in an alternate embodiment the validation is performed utilizing checksum code. A storing step 56 stores the wireless data message in the server memory. A confirming step 58 confirms storage of the wireless data message utilizing server software. A sending step 60 sends the confirmation to the wireless telephone upon confirming storage of the wireless data message in the server memory. A deleting step 62 deletes the wireless data message in the wireless telephone memory utilizing the telephone software upon receipt of the confirmation that the wireless data message was stored in the server memory. The wireless data message 44 contains embedded data 46. The wireless data message 44 contains message content data 48. The embedded data 46 contains content identification data. The embedded data 46 contains telephone identification data. The embedded data 46 contains the caption for the visual image data. The embedded data 46 contains the visual image data date and time stamp for when the visual image data was taken. The embedded data 46 contains the transmission date and time stamp for when the wireless data message was transmitted. The embedded data 46 contains the global positioning system location stamp. The message content data 48 contains visual image data. The message content data 48 contains vocal recording data.

In all, the method of the present invention provides the simple, more automatic and reliable method of transmitting data stored on the wireless device to the remote storage device, confirming safe receipt of that data, and safely deleting the data stored on the wireless device. Optimally, the whole process only takes only the few minutes. If the user of the wireless device leaves its service area, the process may take longer.

It is intended that the description of the present invention presented above is only one embodiment for implementing the invention. As will be apparent to those skilled in the art, different embodiments of the present invention may employ the wide range of possible techniques for managing, transmitting, confirming and deleting data involving both the wireless device and the remote storage device. For example, the embedded data used with the present invention may be the header, the wrapper, or other associative technique. These techniques may contain different kinds of information for use in confirming the successful transmission of messages, including the cyclic redundancy code (CRC), checksum code, and security features designed to protect the remote storage site from unauthorized access.

For another example, this invention's management options on the phone can be expanded widely. The phone's user could specify that data be stored on his wireless telephone 12 in different folders that he sets up. He could also choose different options so that pressing the send key will cause only the data for the most recent photo to be transmitted, or that it will transmit the set of data for multiple photos that he indicates, or that all the image data stored on his phone will be transmitted. In addition, he could specify which data files on his phone are to be deleted after the phone receives confirmation of successful reception at the server and when they are to be deleted. The interface of the wireless device can also employ the great number of additional features, such as, for example progress bars in the displays to show how the transmission of data is proceeding, and may use other input interfaces besides the keyboard, such as the menu. And in addition to message transmission from the wireless device being initiated by the send button, it could be initiated by the menu option or could take place automatically through the user-defined time-out feature or other techniques.

Many methods for managing transmission problems fall within the scope of this invention. For example, if the server receives only part of the message from the phone, it can automatically request that only the remaining part of the message be retransmitted.

Furthermore, the method of the present invention for the transmitting device can be embodied in any wireless device, such as, for example, the camera, laptop, PC, PDA, vending machine or other appliance. And the remote storage device could likewise be any of the wide range of similar devices, such as, for example, home or office PCs, laptops, PDAs, other wireless phones, or other appliances. Moreover, the transmitting and remote storage devices may contain the wide variety of additional hardware, such as speakers, headsets, and voice-recognition systems, useful for recording and managing additional data. The method of the present invention can also be used with other non-wireless point to point data exchange systems, such as, for example, communications over telephone lines. Additional alternatives not specifically disclosed but known in the art are intended to fall within the scope of the invention.

While a preferred embodiment of the apparatus and method of wireless data exchange with automatic delivery confirmation has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present embodiment of the invention.

Therefore, the foregoing is considered as illustrative only of the principles of the embodiment of the invention. Further, since numerous modifications and changes will readily occur to those skilled in the art, it is not desired to limit the embodiment of the invention to the exact construction and operation shown and described, and accordingly, all suitable modifications and equivalents may be resorted to, falling within the scope of the embodiment of the invention.

1. A method of wireless data exchange with automatic delivery confirmation comprising the steps of
managing a wireless data message in a telephone memory of a wireless telephone utilizing telephone software to determine a server memory for remote storage of said wireless data message;
transmitting said wireless data message via a wireless network to said server memory;
storing said wireless data message in said server memory;
confirming storage of said wireless data message utilizing server software; and
sending a confirmation to said wireless telephone upon confirming storage of said wireless data message in said server memory.

2. The method of wireless data exchange with automatic delivery confirmation of claim 1 further comprising the steps of:
deleting said wireless data message in said wireless telephone memory utilizing said telephone software upon receipt of said confirmation that said wireless data message was stored in said server memory.

3. The method of wireless data exchange with automatic delivery confirmation of claim 1 further comprising the steps of:
validating transmission of said wireless data message to said server memory.

4. The method of wireless data exchange with automatic delivery confirmation of claim 2 wherein:
said validation is performed utilizing cyclic redundancy code.

5. The method of wireless data exchange with automatic delivery confirmation of claim 2 wherein:
said validation is performed utilizing checksum code.

6. The method of wireless data exchange with automatic delivery confirmation of claim 1 wherein:
said wireless data message contains embedded data, said wireless data message contains message content data.

7. The method of wireless data exchange with automatic delivery confirmation of claim 5 wherein:
said embedded data contains content identification data, said embedded data contains telephone identification data.

8. The method of wireless data exchange with automatic delivery confirmation of claim 5 wherein:
said embedded data contains a caption for a visual image data.

9. The method of wireless data exchange with automatic delivery confirmation of claim 5 wherein:
said embedded data contains a visual image data date and time stamp for when said visual image data was taken.

10. The method of wireless data exchange with automatic delivery confirmation of claim 5 wherein:
said embedded data contains a transmission date and time stamp for when said wireless data message was transmitted.

11. The method of wireless data exchange with automatic delivery confirmation of claim 5 wherein:
said embedded data contains a global positioning system location stamp.

12. The method of wireless data exchange with automatic delivery confirmation of claim 5 wherein:
said message content data contains visual image data.

13. The method of wireless data exchange with automatic delivery confirmation of claim 5 wherein:
said message content data contains vocal recording data.

14. A method of wireless data exchange with automatic delivery confirmation comprising the steps of:
managing a wireless data message in a telephone memory of a wireless telephone utilizing telephone software to determine a server memory for remote storage of said wireless data message;
transmitting said wireless data message via a wireless network to said server memory;
validating transmission of said wireless data message to said server memory;
storing said wireless data message in said server memory;
confirming storage of said wireless data message utilizing server software;
sending a confirmation to said wireless telephone upon confirming storage of said wireless data message in said server memory; and
deleting said wireless data message in said wireless telephone memory utilizing said telephone software upon receipt of said confirmation that said wireless data message was stored in said server memory.

15. The method of wireless data exchange with automatic delivery confirmation of claim 14 wherein:
said validation is performed utilizing checksum code.

16. The method of wireless data exchange with automatic delivery confirmation of claim 15 wherein:
said wireless data message contains embedded data, said wireless data message contains message content data, said message content data contains visual image data.

17. The method of wireless data exchange with automatic delivery confirmation of claim 16 wherein:
said embedded data contains content identification data, said embedded data contains telephone identification data, said embedded data contains a caption for a visual image data, said embedded data contains a visual image data date and time stamp for when said visual image data was taken, said embedded data contains a transmission date and time stamp for when said wireless data message was transmitted.

18. The method of wireless data exchange with automatic delivery confirmation of claim 17 wherein:
said embedded data contains a global positioning system location stamp.

19. The method of wireless data exchange with automatic delivery confirmation of claim 18 wherein:
said message content data contains vocal recording data.

20. An apparatus for wireless data exchange with automatic delivery confirmation comprising:
means for managing a wireless data message in a telephone memory of a wireless telephone utilizing telephone software to determine a server memory for remote storage of said wireless data message;
means for transmitting said wireless data message via a wireless network to said server memory;
means for validating transmission of said wireless data message to said server memory;
means for storing said wireless data message in said server memory;
means for confirming storage of said wireless data message utilizing server software;
means for sending a confirmation to said wireless telephone upon confirming storage of said wireless data message in said server memory; and
means for deleting said wireless data message in said wireless telephone memory utilizing said telephone software upon receipt of said confirmation that said wireless data message was stored in said server memory.
